(19) United States
(12) Patent Application Publication
(10) Pub. No.: US 2007/0089556 A1
(43) Pub. Date: Apr. 26, 2007

(54) Apparatus for shift control

(76) Inventor: Hong Ho Kim, Hwaseong-city (KR)

Correspondence Address: MORGAN, LEWIS & BOCKIUS LLP (SF), 2 PALO ALTO SQUARE, 3000 El Camino Real, Suite 700, PALO ALTO, CA, 94306, US

(21) Appl. No.: 11/302,081

(22) Filed: Dec. 12, 2005

(30) Foreign Application Priority Data
Oct. 20, 2005 (KR) 10-2005-0099195

(51) Int. Cl. F16H 59/04

(52) U.S. Cl. 74/473.3

(57) ABSTRACT

An apparatus for shift control of a transmission includes a transmission control unit (TCU) and an actuator for actuating an input by a shift signal from the TCU. A movable control shaft moving by way of the actuator and a plurality of shift forks are able to move a shift position for realizing odd-numbered shift-speeds, even-numbered shift-speeds, or a neutral position. A plurality of shift lugs are secured to and move integrally with a plurality of shift forks. A control finger unit is secured to the control shaft and moves at least one of the plurality of shift lugs corresponding to movement from the control shaft. The control finger unit moves the shift lugs such that shift lugs for realizing an odd-numbered shift-speed are not located together at a shift position and that shift lugs for realizing an even-numbered shift-speed are not located together at a shift position.

### CROSS-REFERENCE TO RELATED APPLICATION

This application claims priority to and benefit from Korean Patent Application No. 10-2005-0099195 filed in the Korean Intellectual Property Office on Oct. 20, 2005, the entire content of which is incorporated herein by reference.

### BACKGROUND OF THE INVENTION

(a) Field of the Invention

Generally, the present invention relates to an apparatus for shift control. More particularly, the apparatus for shift control can prevent a malfunction of a transmission.

(b) Description of the Related Art

Typically, a scheme of a manual transmission is different from a scheme of an automatic transmission. Movement generated in a shift lever of a transmission is transmitted to a control shaft and the shifting of the transmission is performed by way of a control finger that moves and rotates by a movement and a rotation of the control shaft. That is, by operation of the shift lever, the control finger rotates and contacts a shift lug corresponding to a predetermined shift-speed. If the shift lug moves by the rotation of the control finger, the shifting is realized by a movement of a shift rail. In a case that another shift-speed is selected by the shift lever, if the other shift lug moves, the shifting is realized by a movement of a shift rail. At that time, an interlock plate is disposed such that the control finger moves in a predetermined direction.

For realizing an automated manual transmission utilizing the scheme of the manual transmission (double clutch transmission), two shift-speeds are simultaneously located to shift positions and two clutches are utilized. That is, one of the two shift-speeds is engaged and the other is not engaged. In addition, one of the shift-speeds located at the shift position has to be an odd-numbered shift-speed and the other has to be an even-numbered shift-speed.

However, because shifting can be realized for only one shift-speed according to the prior art, a drawback is that the two shift-speeds cannot be simultaneously engaged even though an actuator is mounted to the manual transmission. In addition, another drawback is that one odd-numbered shift-speed and one even-numbered shift-speed are not simultaneously located to the shift positions respectively, according to the manual transmission of the prior art. That is, the manual transmission according to the prior art cannot be utilized as an automated manual transmission.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention provides an apparatus for shift control that utilizes the scheme of a manual transmission, however, shifting is automatically operated by an actuator. That is, the transmission of the present invention is called an automated manual transmission. The transmission includes an apparatus for shift control that simultaneously locates an odd-numbered shift-speed and an even-numbered shift-speed.

An exemplary apparatus for shift control of a transmission of a vehicle according to an embodiment of the present invention includes a transmission control unit (TCU), an actuator for actuating an input by a shift signal from the TCU, and a control shaft moving or rotating in a lengthwise direction thereof by the actuator. The transmission also includes a plurality of shift forks being able to move a shift position realizing odd-numbered shift-speeds or even-numbered shift-speeds or a neutral position. A plurality of shift lugs, secured to the respective plurality of shift forks, move integrally with the plurality of shift forks and defining penetrating holes in which the control shaft is inserted. Also, a control finger unit, secured to the control shaft, moves at least one of the plurality of shift lugs corresponding to a movement and rotation of the control shaft. The control finger unit moves the plurality of shift lugs such that the shift lugs, for realizing odd-numbered shift-speeds, are not located together at a shift position thereof and that the shift lugs, for realizing even-numbered shift-speeds, are not located together at a shift position thereof.

The control finger unit can operate in a state that one shift lug is operated, such that the other shift lug can be operated after the one shift lug of the plurality of shift lugs is operated by the shift signal.

The control finger unit includes an engage finger formed to operate the shift lug corresponding to the shift signal. A disengage finger operates the shift lug such that a shift lug corresponding to another odd-numbered shift-speed is located in a neutral position in a case that a shift-speed corresponding to the shift signal is one odd-numbered shift-speed. The disengage finger also operates the shift lug such that a shift lug corresponding to another even-numbered shift-speed is located in a neutral position in a case that a shift-speed corresponding to the shift signal is one even-numbered shift-speed.

The engage finger and the disengage finger are located apart from each other by a predetermined distance. The shift lug moves at least one position such that the shift fork realizes at least one shift-speed, and the shift lug for realizing the odd-numbered shift-speed and the shift lug for realizing the even-numbered shift-speed are alternately disposed. The control finger unit is formed to protrude in a direction perpendicular to a length direction of the control shaft, and it moves the shift lug by transmitting a torque of the control shift to an inner surface of a penetrating hole formed in the shift lug.

The engage finger is formed to be longer than the disengage finger to move the shift lug to a position such that shifting corresponding to the shift signal is realized, and the disengage finger is formed such that at least one disengage finger is formed to both outer circumferences of the control shaft. According to some embodiments, the engage finger and the disengage finger are disposed on the same plane.

### BRIEF DESCRIPTION OF THE DRAWINGS

FIG. 1 shows an apparatus for shift control according to an exemplary embodiment of the present invention;

FIG. 2 shows a control shaft and a control finger unit according to an exemplary embodiment of the present invention;

FIG. 3 shows an operation of a control finger and a shift lug of an apparatus for shift control according to an exemplary embodiment of the present invention; and

FIG. 4 shows an operation of a control finger unit of an apparatus for shift control according to an exemplary embodiment of the present invention.

### DETAILED DESCRIPTION OF THE EMBODIMENTS

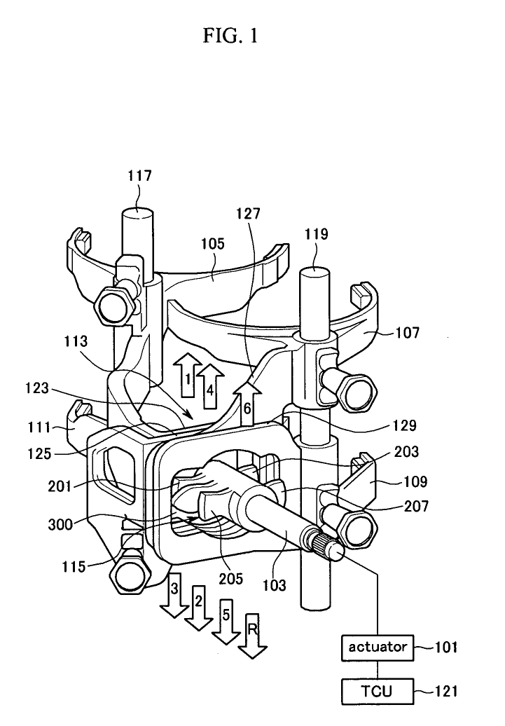

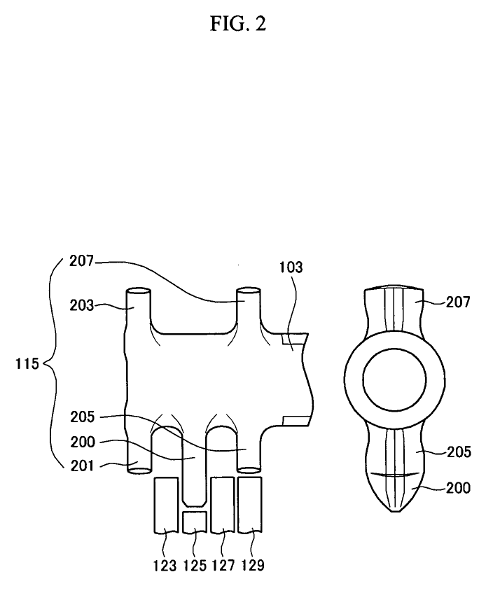

Referring to FIGS. 1 and 2, an apparatus for shift control of a transmission of a vehicle according to an exemplary embodiment of the present invention includes a shift control unit (TCU: transmission control unit) 121, an actuator 101, a control shaft 103, a plurality of shift forks 105, 107, 109, and 111, a plurality of shift lugs 113, and a control finger unit 115. The actuator 101 actuates an input by a shift signal from the TCU 121, and the control shaft 103 moves or rotates in a lengthwise direction thereof by way of the actuator 101.

The plurality of shift forks 105, 107, 109, and 111 are able to move a shift position to realize odd-numbered shift-speeds, even-numbered shift-speeds, or a neutral position. The plurality of shift lugs 123, 125, 127, and 129 are respectively secured to a plurality of shift forks 105, 107, 109, and 111 to move integrally with the plurality of shift forks 105, 107, 109, and 111, and define penetrating holes 300 in which the control shaft 103 is inserted. The control finger unit 115 is secured to the control shaft 103 to move at least one of the plurality of shift lugs 123, 125, 127, and 129 corresponding to a movement and rotation of the control shaft 103.

If a shift signal is output by the TCU 121 corresponding to a state of a shifting vehicle, the actuator 101 receives the shift signal. The actuator 101 then moves or rotates the control shaft 103 corresponding to the shift signal. According to an exemplary embodiment of the present invention, the shift lugs include four shift lugs 123, 125, 127, and 129, and the number of shift lugs can be changed with respect to a number of shift-speeds of gears which is easily understood by a person of ordinary skill in the art.

According to an exemplary embodiment of the present invention, the shift lugs 123, 125, 127, and 129 include a first and third speed shift lug 123, a second and fourth speed shift lug 125, a fifth speed shift lug 127, and a sixth and reverse speed shift lug 129. In use, after the control shaft 103 moves, if the control shaft 103 rotates, the corresponding shift lugs 123, 125, 127, and 129 move in an upper direction or lower direction in the drawings. If the shift forks 105, 107, 109, and 111 connected to the respective shift lugs 123, 125, 127, and 129 move corresponding to a movement of the shift lugs 123, 125, 127, and 129, shifting of the transmission is realized. The respective shift forks 105, 107, 109, and 111 are connected to shift rails 117 and 119.

More particularly, if the first and third speed shift lug 123 moves in the upper direction in the drawing the first speed shift is realized, and if it moves in the lower direction the third speed shift is realized. If the second and fourth speed shift lug 125 moves in the upper direction the fourth speed shift is realized, and moves the lower direction the second speed shift is realized. If the fifth speed shift lug 127 moves in the lower direction the fifth speed shift is realized, and if the sixth and reverse speed shift lug 129 moves in the upper direction the sixth speed shift is realized and if it moves in the lower direction the reverse range shift is realized.

The control finger unit 115 includes an engage finger 200 and disengage fingers 201, 203, 205, and 207. The engage finger 200 is formed to move the shift lugs 123, 125, 127, and 129 to the shift positions. The shift lugs 113 move at least one position such that shift forks 105, 107, 109, and 111 realize at least one shift-speed. In addition, the shift lugs for realizing the odd-numbered shift-speeds and the shift lugs for realizing the even-numbered shift-speeds are alternately disposed. That is, as shown in FIG. 2, for example, the first and third speed shift lug 132, the second and fourth speed shift lug 125, the fifth speed shift lug 127, and the sixth and reverse speed shift lug 129 are successively disposed, but the present invention is not limited thereto. That is, if the control shaft 103 rotates, as described, the shift lugs 123, 125, 127, and 129 move to the shift positions by the engage finger 200. For example, FIG. 2 shows that the second and fourth speed shift lug 125 is located at the second speed position.

An operation of the apparatus for the shift control according to an exemplary embodiment of the present invention is described hereinafter.

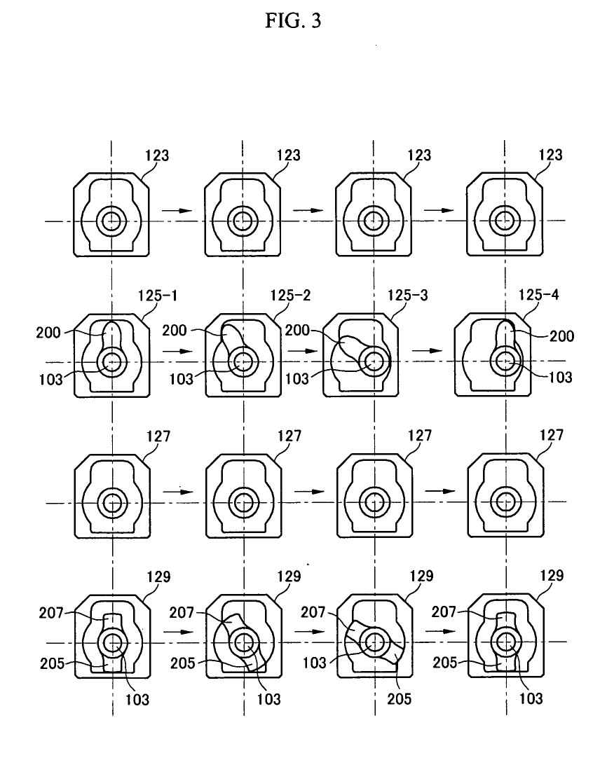

Referring now to FIG. 3, according to an exemplary embodiment of the present invention, in a case that the engage finger 200 moves the shift lug 125 to the second shift position, the control shaft 103 moves such that the engage finger 200 is located at a hole of the second and fourth shift lugs 125 at 125-1. The control shaft 103 then moves the second and fourth shift lug 125 to the second shift position at 125-2 and 125-3 by rotating in a counterclockwise direction. Then, even though the engage finger 200 moves back to the original position by rotating in a clockwise direction, the second and fourth shift lug 125 does not move to a neutral position at 125-4.

Therefore, after one shift lug 125 of the plurality of shift lug 123, 125, 127, and 129 is operated by the shift signal, the control finger unit 115 can operate the other shift lug in a state that one shift lug is operated. That is, in the state that the second and fourth shift lug 125 moves to the second shift position at 125-4, the control shaft 103 can move to the other holes of the shift lugs 123, 127, and 129.

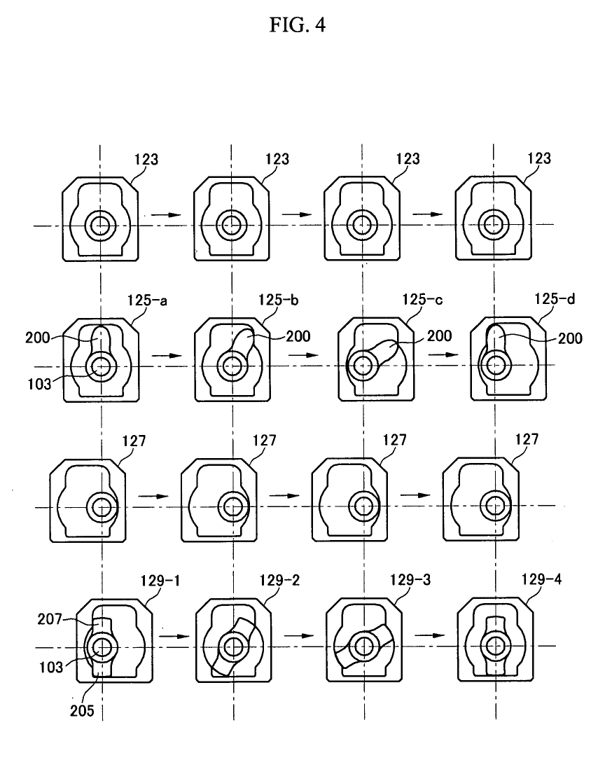

Referring to FIG. 4, the control finger unit 115 moves the plurality of shift lugs 123 and 127 such that the odd-numbered shift-speeds are not located together at a shift position thereof. In addition, the control finger unit 115 moves the plurality of shift lugs 125 and 129 such that the even-numbered shift-speeds are not located together at a shift position thereof. That is, the control finger unit 115 is formed to move the plurality of shift lugs 123, 125, 127, and 129 simultaneously. If the shift lugs 123 and 127 for realizing the odd-numbered shift-speeds or the shift lugs 125 and 129 for realizing the even-numbered shift-speeds are located together at the same odd or even shift position, the vehicle stops and an operation as described below is realized.

The state shown in FIG. 4, in a case that the vehicle drives at the fifth shift-speed, is that the TCU 121 predicts that the speed of the vehicle is increasing and moves the sixth and reverse speed shift lug 129 to the sixth-speed shift position. In addition, in the state described above, the state shown in FIG. 4 illustrates that the speed of the vehicle actually decreases and the TCU 121 moves the second and fourth shift lug 125 to the fourth-speed shift position. At that time, because the sixth and reverse speed shift lug 129 is already located to the sixth-speed shift position, if the second and fourth shift lug 125 moves to the fourth-speed shift position, the vehicle stops.

In order to prevent the state described above, the control finger unit 115 includes disengage fingers 201, 203, 205, and 207 such that the two odd-numbered shift-speeds cannot be located at the shift positions simultaneously or the two even-numbered shift-speeds cannot be located at the shift positions simultaneously. In a case that the shift-speed corresponding to the shift signal is the odd-numbered shift-speed, the disengage fingers 201, 203, 205, and 207 operate the shift lug 123 or 127 such that the shift lug corresponding to the other odd-numbered shift-speed is located at the neutral position. In addition, in a case that the shift-speed corresponding to the shift signal is the even-numbered shift-speed, the disengage fingers 201, 203, 205, and 207 operate the shift lug 125 or 129 such that the shift lug corresponding to the other even-numbered shift-speed is located at the neutral position.

As described above, in order to operate the shift lugs 113, the engage finger 200 and the disengage fingers 201, 203, 205, and 207 are located apart from each other by a predetermined distance. The control finger unit 115 is formed to protrude in a direction perpendicular to a length direction of the control shaft 103. In addition, the control finger unit 155 moves the shift lug 123, 125, 127, and 129 by transmitting a torque of the control shift 103 to an inner surface of a penetrating hole 300 formed in the shift lugs 123, 125, 127, and 129. The engage finger 200 is formed to be longer than the disengage finger to move the shift lugs 123, 125, 127, and 129 to a position that the shifting corresponding to the shift signal is realized. The disengage fingers 201, 203, 205, and 207 are formed such that at least one disengage finger is formed to both outer circumferences of the control shaft 103. The engage finger 200 and the disengage fingers 201, 203, 205, and 207 are disposed on the same plane.

As shown in FIG. 4, in order that the engage finger 200 moves the second and fourth speed shift lug 125 to the fourth speed shift position, the engage finger 200 is located to the hole formed in the second and fourth speed shift lug 125 at 125-a. Simultaneously, the disengage fingers 205 and 207 are located to the holes formed in the sixth speed and reverse speed shift lug 129 at 129-1. Then, if the control shaft 103 rotates in the clockwise direction, the second and fourth shift lug 125 moves to the fourth speed shift position by the engage finger 200 at 125-b and 125-c. Simultaneously, the sixth and reverse speed shift lug 129 moves to the neutral position by the disengage finger 205 and 207 at 129-2 and 129-3.

Therefore, because the fourth shift lug 125 and the sixth and reverse speed shift lug 129 are not located to the shifting positions simultaneously by the disengage finger 205 and 207, a malfunction of the shift lug 113 can be prevented. Therefore, the vehicle does not stop and damage to the transmission can be prevented.

According to an exemplary embodiment of the present invention, because the odd-numbered shift-speed and the even-numbered shift-speed can be respectively and simultaneously engaged, more efficient shifting can be realized. In addition, because two odd-numbered shift-speeds and two even-numbered shift-speeds are not operated simultaneously, a malfunction of the transmission can be prevented. Furthermore, according to an exemplary embodiment of the present invention, the apparatus for the shift control can be utilized in an automated manual transmission and also in a manual transmission, and therefore manufacturing costs can be reduced and productivity can be enhanced. Moreover, because the apparatus for the shift control has a simple scheme, manufacturing costs can be reduced.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. An apparatus for shift control of a transmission of a vehicle, comprising:
a transmission control unit (TCU);
an actuator for actuating an input by a shift signal from the TCU;
a movable control shaft moving by way of the actuator;
a plurality of shift forks able to move a shift position for realizing odd-numbered shift-speeds, even-numbered shift-speeds, or a neutral position;
a plurality of shift lugs secured to the respective plurality of shift forks to move integrally with the plurality of shift forks and defining penetrating holes through which the control shaft is inserted; and
a control finger unit secured to the control shaft to move at least one of the plurality of shift lugs corresponding to a movement of the control shaft, wherein:
the control finger unit moves the plurality of shift lugs such that shift lugs for realizing an odd-numbered shift-speed are not located together at a shift position thereof and that shift lugs for realizing an even-numbered shift-speed are not located together at a shift position thereof.

2. The apparatus of claim 1, wherein the control finger unit operates, in a state that one shift lug is operated, such that another shift lug can be operated after the one shift lug of the plurality of shift lugs is operated by the shift signal.

3. The apparatus of claim 1, wherein the control finger unit comprises:
an engage finger formed to operate a shift lug that corresponds to a shift signal; and
a disengage finger that operates the shift lug such that a shift lug corresponding to another odd-numbered shift-speed is located in a neutral position in a case that a shift-speed corresponding to the shift signal is one odd-numbered shift-speed, and operates the shift lug such that a shift lug corresponding to another even-numbered shift-speed is located in a neutral position in a case that a shift-speed corresponding to the shift signal is one even-numbered shift-speed.

4. The apparatus of claim 3, wherein the engage finger and the disengage finger are located apart from each other by a predetermined distance.

5. The apparatus of claim 3, wherein the shift lug moves at least one position such that the shift fork realizes at least one shift-speed, and the shift lug for realizing the odd-numbered shift-speed and the shift lug for realizing the even-numbered shift-speed are alternately disposed.

6. The apparatus of claim 5, wherein the control finger unit is formed to protrude in a direction perpendicular to a length direction of the control shaft, and the control finger unit moves the shift lug by transmitting a torque of the control shift to an inner surface of a penetrating hole formed in the shift lug.

7. The apparatus of claim 6, wherein the engage finger is longer than the disengage finger to move the shift lug to a position such that the shifting is realized corresponding to the shift signal, and
the disengage finger is formed such that at least one disengage finger is formed to both outer circumferences of the control shaft.

8. The apparatus of claim 7, wherein the engage finger and the disengage finger are disposed substantially on the same plane.
